(19) United States
(12) Patent Application Publication
(10) Pub. No.: US 2026/0200536 A1
(43) Pub. Date: Jul. 16, 2026

(54) VEHICLE SKELETON STRUCTURE

(71) Applicant: TOYOTA JIDOSHA KABUSHIKI KAISHA, Toyota-shi (JP)

(72) Inventors: Ayaka KAGAMI, Inazawa-shi (JP); Soshiro Murata, Toyota-shi (JP)

(73) Assignee: TOYOTA JIDOSHA KABUSHIKI KAISHA, Toyota-shi (JP)

(21) Appl. No.: 19/405,937

(22) Filed: Dec. 2, 2025

(30) Foreign Application Priority Data
Jan. 16, 2025 (JP) 2025-006388

(51) Int. Cl. B62D 27/02; B62D 25/04; B62D 25/08

(52) U.S. Cl. CPC B62D 27/023; B62D 25/04; B62D 25/085

(57) ABSTRACT

The vehicle skeleton structure includes a front skeleton body integrally formed by casting including a dash portion disposed at a vehicle front portion and extending in a vehicle width direction, and a front side member portion extending from the dash portion toward a vehicle front side, a front pillar formed separately from the front skeleton body and attached to a rear end portion of the front skeleton body and extending in a vehicle vertical direction, and a coupling member disposed on an outer side of the front skeleton body in the vehicle width direction and connecting the front skeleton body and the front pillar.

### CROSS-REFERENCE TO RELATED APPLICATION

This application claims priority to Japanese Patent Application No. 2025-006388 filed on January 16, 2025. The disclosure of the above-identified application, including the specification, drawings, and claims, is incorporated by reference herein in its entirety.

### BACKGROUND

### 1. Technical Field

The present disclosure relates to a vehicle skeleton structure.

### 2. Description of Related Art

Chinese Patent Publication No. 117068276 discloses a structure in which a skeleton of a vehicle front portion is constituted of a die-cast part integrally formed by casting.

### SUMMARY

In a structure in which a skeleton of a vehicle front portion of the vehicle is integrally formed by casting, such as the structure described in Chinese Patent Publication No. 117068276, there is a possibility that a front pillar is detached from the cast skeleton when a tire is retracted at the time of a collision of the vehicle, and there is room for improvement.

An object of the present disclosure is to provide a vehicle skeleton structure in which a skeleton of a vehicle front portion is formed by casting, and in which detachment of a front pillar can be suppressed at the time of a collision of the vehicle.

A first aspect provides a vehicle skeleton structure including: a front skeleton body integrally constituted by casting and including a dash portion disposed in a vehicle front portion and extending in a vehicle width direction, and a front side member portion extending from the dash portion toward a vehicle front side; a front pillar constituted separately from the front skeleton body, attached to a rear end portion of the front skeleton body, and extending in a vehicle up-down direction; and a coupling member disposed on a vehicle width direction outer side of the front skeleton body and coupling the front skeleton body and the front pillar.

In the vehicle skeleton structure according to the first aspect, the front skeleton body is integrally formed by casting, and includes a dash portion and a front side member portion. In addition, a front pillar is formed separately from the front skeleton body, is attached to a rear end portion of the front skeleton body, and extends in the vehicle up-down direction. Further, a coupling member is disposed on the vehicle width direction outer side of the front skeleton body, and the front skeleton body and the front pillar are coupled by the coupling member. Accordingly, detachment of the front pillar can be suppressed even when a tire is retracted at the time of a collision of the vehicle.

A second aspect provides the vehicle skeleton structure according to the first aspect, in which: the front pillar is configured to include a pillar inner panel located on a vehicle width direction inner side, and a pillar outer panel located on the vehicle width direction outer side; and the coupling member extends to a surface of the pillar outer panel on the vehicle width direction outer side.

In the vehicle skeleton structure according to the second aspect, the coupling member extends to a surface of the pillar outer panel on the vehicle width direction outer side, and therefore detachment of the front pillar can be effectively suppressed.

A third aspect provides the vehicle skeleton structure according to the first aspect, in which: a front end of a rocker that extends in a vehicle front-rear direction is connected to a lower end portion of the front pillar; the rocker is disposed on a vehicle lower side with respect to the front skeleton body; and a battery is provided on a vehicle width direction inner side with respect to the rocker.

In the vehicle skeleton structure according to the third aspect, a collision load can be transmitted from the front skeleton body to the rocker via the front pillar. In addition, the rocker is disposed on the vehicle lower side with respect to the front skeleton body, a battery is provided on the vehicle width direction inner side of the rocker, and therefore it is possible to secure a large vehicle cabin space even when the battery is mounted as compared with when the rocker is located at the same height as the front skeleton body. Here, the expression "the rocker is disposed on the vehicle lower side with respect to the front skeleton body" is not limited to a configuration in which the entire rocker is disposed on the vehicle lower side with respect to the front skeleton body. The expression "the rocker is disposed on the vehicle lower side with respect to the front skeleton body" conveys a concept broadly including a configuration in which the lower end portion of the rocker is disposed on the vehicle lower side with respect to the front skeleton body. That is, the expression includes a configuration in which the upper portion of the rocker and the front skeleton body overlap each other when viewed from the vehicle front-rear direction.

A fourth aspect provides the vehicle skeleton structure according to the third aspect, in which the coupling member extends to the rocker.

In the vehicle skeleton structure according to the fourth aspect, the front skeleton body, the front pillar, and the rocker are coupled by the coupling member, and therefore the effect of suppressing detachment of the front pillar can be improved as compared with a structure in which the coupling member does not extend to the rocker.

A fifth aspect provides the vehicle skeleton structure according to the third aspect, in which: the front skeleton body includes an extension portion that extends downward from the dash portion; and the extension portion extends in the vehicle width direction and is connected to a front end portion of the rocker.

In the vehicle skeleton structure according to the fifth aspect, the extension portion is connected to the front end portion of the rocker, and therefore the extension portion can function as a cross member of a battery case. As a result, the number of components of the battery case can be reduced.

As described above, according to the vehicle skeleton structure of the present disclosure, it is possible to suppress detachment of a front pillar at the time of a collision of the vehicle in a structure in which a skeleton of a vehicle front portion is formed by casting.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a main part of a vehicle skeleton structure according to an embodiment;

FIG. 2 is a side view illustrating a main part of the vehicle skeleton structure according to the embodiment;

FIG. 3 is an enlarged cross-sectional view showing an enlarged view taken along the line III-III of FIG. 2;

FIG. 4 is a side view showing a main part of a vehicle skeleton structure according to a first modification; and

FIG. 5 is a perspective view illustrating a main part of a vehicle skeleton structure according to a second modification.

### DETAILED DESCRIPTION OF EMBODIMENTS

A vehicle skeleton structure according to an embodiment will be described with reference to the drawings.

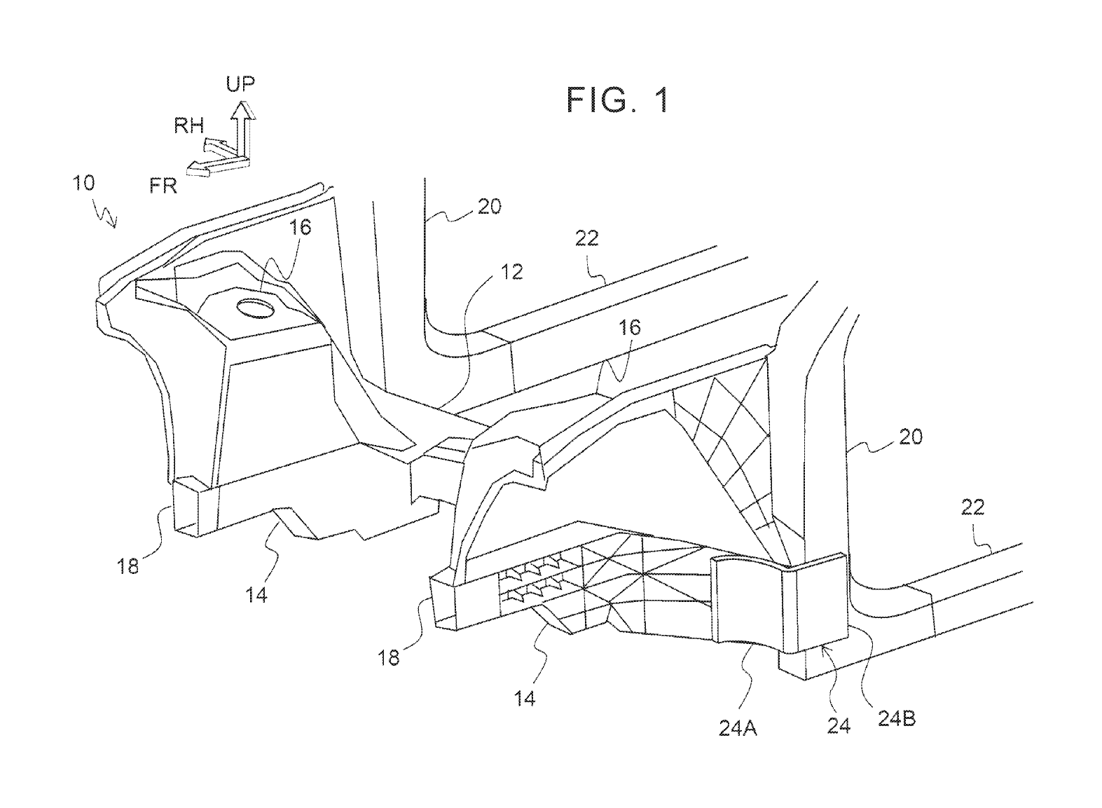

FIG. 1 is a perspective view illustrating a main part of a vehicle skeleton structure according to an embodiment. Incidentally, arrow FR in the diagram, arrow UP, arrow RH, arrow LH, respectively, the vehicle front direction in the vehicle, the vehicle upper direction, the vehicle right direction and the vehicle left direction It shows. In the following description, when the front, rear, up, down, and left and right directions are used without special mention, the front and rear directions in the vehicle front-rear direction, the up and down directions in the vehicle up-down direction, and the left and right directions in the vehicle left-right direction (width direction) are respectively indicated.

As shown in FIG. 1, the front skeleton body 10 constituting the vehicle skeleton structure is a component arranged in the front portion of the vehicle, and is formed by casting. The front skeleton body 10 of the present embodiment is a die-cast component mainly composed of an aluminum alloy integrally formed by casting including the dash portion 12, the front side member portion 14, and the suspension tower portion 16.

The dash portion 12 extends in the vehicle width direction and constitutes a part of a member that partitions the vehicle cabin space and the outside of the vehicle cabin (power unit room).

Front side member portions 14 extend from both end portions in the vehicle width direction of dash portion 12 toward the vehicle front side. A suspension tower portion 16 is provided above the front side member portion 14. Like the front side member portion 14, the suspension tower portion 16 is provided with a pair of left and right portions, and has a structure capable of supporting the illustrated suspension by expanding toward the vehicle upper side.

A connection portion 18 having a substantially rectangular cylindrical shape is provided at a front end portion of the front side member portion 14. The rear end portion of the connection portion 18 is fixed to the front side member portion 14, and a frame (not shown) is connected to the front end portion of the connection portion 18. A bumper reinforcement extending in the vehicle width direction is attached to the frame.

The front side member portion 14 is formed in an open cross-sectional shape in which an opening is provided on one side in the vehicle width direction, and a plurality of ribs are provided in the cross-section of the front side member portion 14.

A front pillar 20 is disposed on the vehicle rear side of the front skeleton body 10. The front pillar 20 is formed separately from the front skeleton body 10 and extends in the vehicle vertical direction. Further, in the present embodiment, two steel plates are included as an example. Details of the front pillar 20 will be described later.

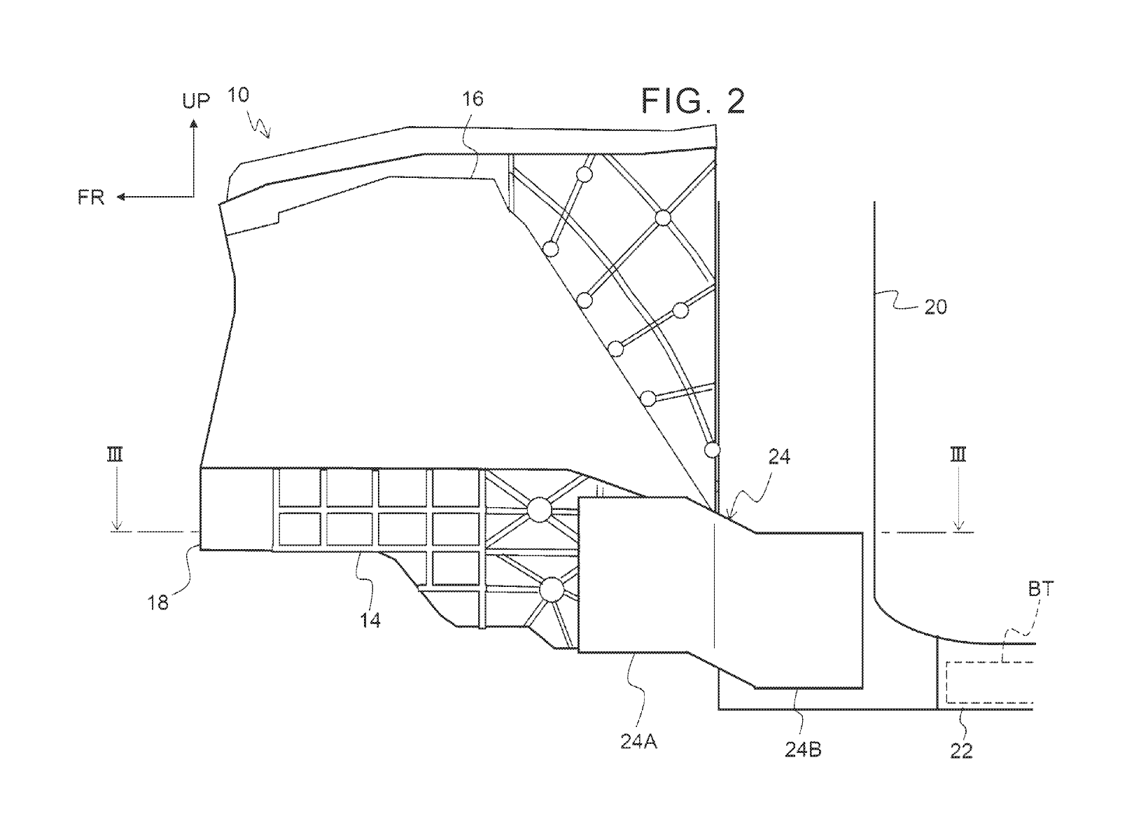

FIG. 2 is a side view illustrating a main part of the vehicle skeleton structure according to the embodiment. As shown in FIGS. 1 and 2, a front end of a rocker 22 extending in the vehicle front-rear direction is connected to a lower end portion of the front pillar 20.

A pair of left and right rockers 22 are provided, and each rocker extends in the vehicle front-rear direction. Further, the rocker 22 is disposed on the vehicle lower side than the front skeleton body 10. Specifically, the upper portion of the rocker 22 is positioned at the same height as the lower portion of the front skeleton body 10, and the lower end portion of the rocker 22 is disposed on the vehicle lower side than the lower end of the front skeleton body 10.

A battery BT is disposed between the pair of left and right rockers 22. The battery BT stores electric power to be supplied to a motor (not shown), which is a driving source of the vehicle, and is configured to drive the vehicle when electric power is supplied from the battery BT to the motor.

A vehicle cabin space is formed above the battery BT. The upper surface of the battery case protecting the battery BT may function as a floor panel, and a floor panel separate from the battery case may be provided.

Here, the front skeleton body 10 and the front pillar 20 are connected to each other in the vehicle front-rear direction by a coupling member 24. The coupling member 24 is disposed outside the front skeleton body 10 in the vehicle width direction, and is formed by a substantially plate-shaped member.

The coupling member 24 mainly includes a front curved portion 24A attached to the front side member portion 14 and a rear flat plate portion 24B attached to the front pillar 20. The front curved portion 24A is curved along the shape of the rear portion of the front side member portion 14.

Specifically, the front curved portion 24A is curved so as to bulge inward in the vehicle-width direction, and is fastened to the rear end portion of the front side member portion 14 by a fastener (not shown). Therefore, a part of the opening of the rear portion of the front side member portion 14 is covered from the vehicle-width-direction outer side by the front curved portion 24A.

Further, the rear flat plate portion 24B extends from the rear end of the front curved portion 24A toward the rear side of the vehicle, and is formed in a substantially flat plate shape. Here, as shown in FIG. 2, in the present embodiment, as an example, a part of the coupling member 24 between the front curved portion 24A and the rear flat plate portion 24B is inclined toward the vehicle lower side from the vehicle front side toward the vehicle lower side, but the present disclosure is not limited thereto. That is, the front curved portion 24A and the rear flat plate portion 24B may extend at the same height.

The rear flat plate portion 24B is fastened by a fastener (not shown) while being superposed on the vehicle-width-direction outer surface of the front pillar 20. A method of fastening the coupling member 24 to the front side member portion 14 and the front pillar 20 is not particularly limited. For example, bolts, nuts, rivets, clips, and the like may be used for fastening. In addition, the coupling member 24 may be fixed to the front side member portion 14 and the front pillar 20 by other methods, and may be fixed by welding or the like, for example.

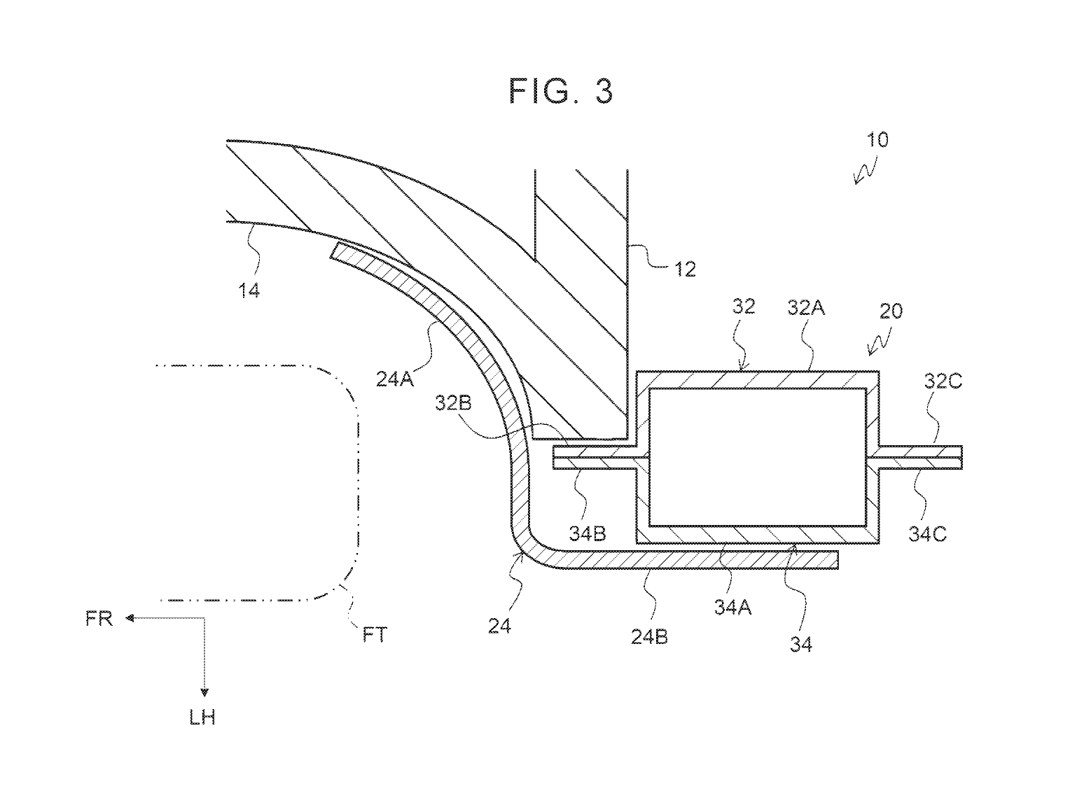

FIG. 3 is an enlarged cross-sectional view taken along III-III line of FIG. 2. As shown in FIG. 3, the front pillar 20 includes a pillar inner panel 32 positioned on the vehicle width direction inner side and a pillar outer panel 34 positioned on the vehicle width direction outer side.

The pillar inner panel 32 includes an inner body 32A having a substantially U-shaped cross section. Further, an inner side front flange 32B extends from a front end of the inner body 32A toward a vehicle front side, and an inner side rear flange 32C extends from a rear end of the inner body 32A toward a vehicle rear side. Therefore, the pillar inner panel 32 is formed in a substantially hat-shaped cross section when viewed from above the vehicle.

The pillar outer panel 34 includes an outer body 34A having a substantially U-shaped cross-section that is open to the vehicle-width-direction inner side. Further, an outer side front flange 34B extends from a front end of the outer body 34A toward a vehicle front side, and an outer side rear flange 34C extends from a rear end of the outer body 34A toward a vehicle rear side. Therefore, the pillar outer panel 34 is formed in a substantially hat-shaped cross section when viewed from above the vehicle.

The inner side front flange 32B of the pillar inner panel 32 and the outer side front flange 34B of the pillar outer panel 34 are joined to each other by welding or the like in a superimposed manner. Further, the inner side rear flange 32C of the pillar inner panel 32 and the outer side rear flange 34C of the pillar outer panel 34 are joined to each other by welding or the like while being superposed. In this manner, the front pillar 20 has a closed cross-sectional structure, and is attached to the front skeleton body 10 by bolts, nuts, rivets, clips, and the like.

Here, the coupling member 24 extends to the vehicle-width-direction outer side surface of the pillar outer panel 34 in the front pillar 20, that is, to the outer body 34A, and is fastened to the outer body 34A.

### Operations

Next, the operation of the vehicle skeleton structure according to the present embodiment will be described.

As shown in FIG. 1, in the vehicle skeleton structure according to the present embodiment, as shown in FIG. 1, the front skeleton body 10 includes a dash portion 12 and a front side member portion 14 and is integrally formed by casting. Further, the front pillar 20 is formed separately from the front skeleton body 10, and is attached to the rear end portion of the front skeleton body 10 and extends in the vehicle vertical direction.

Further, a coupling member 24 is disposed on the vehicle width direction outer side of the front skeleton body 10, and the front skeleton body 10 and the front pillar 20 are coupled by the coupling member 24. Accordingly, even when the tire is retracted when the vehicle collides, it is possible to suppress detachment of the front pillar.

That is, as shown in FIG. 3, when the front wheel FT is disposed on the vehicle front side of the front pillar 20, even when the front wheel FT is retracted when the vehicle collides, the front wheel FT does not come into contact with the front pillar 20 and comes into contact with the coupling member 24. Thus, the fastening state between the front pillar 20 and the front skeleton body 10 can be maintained satisfactorily.

In particular, when the front curved portion 24A of the coupling member 24 is curved along the front side member portion 14 as in the present embodiment, the direction is changed by contacting the front curved portion 24A with the retracted front wheel FT. Accordingly, it is possible to suppress input of a load from the front wheel FT to the fixed part between the front pillar 20 and the front skeleton body 10.

Further, in the present embodiment, since the coupling member 24 extends to the surface of the pillar outer panel 34 outside in the vehicle width direction, detachment of the front pillar 20 can be effectively suppressed.

Further, in the present embodiment, as shown in FIG. 2, since the rocker 22 is connected to the lower end portion of the front pillar 20, a collision load can be transmitted from the front skeleton body 10 to the rocker 22 via the front pillar 20. Further, the rocker 22 is disposed below the front skeleton body 10, and a battery BT is provided on the vehicle widthwise inner side of the rocker 22. As a result, even when the battery BT is mounted, the vehicle cabin space can be secured to be wider than when the rocker 22 is set at the same height as the front skeleton body 10.

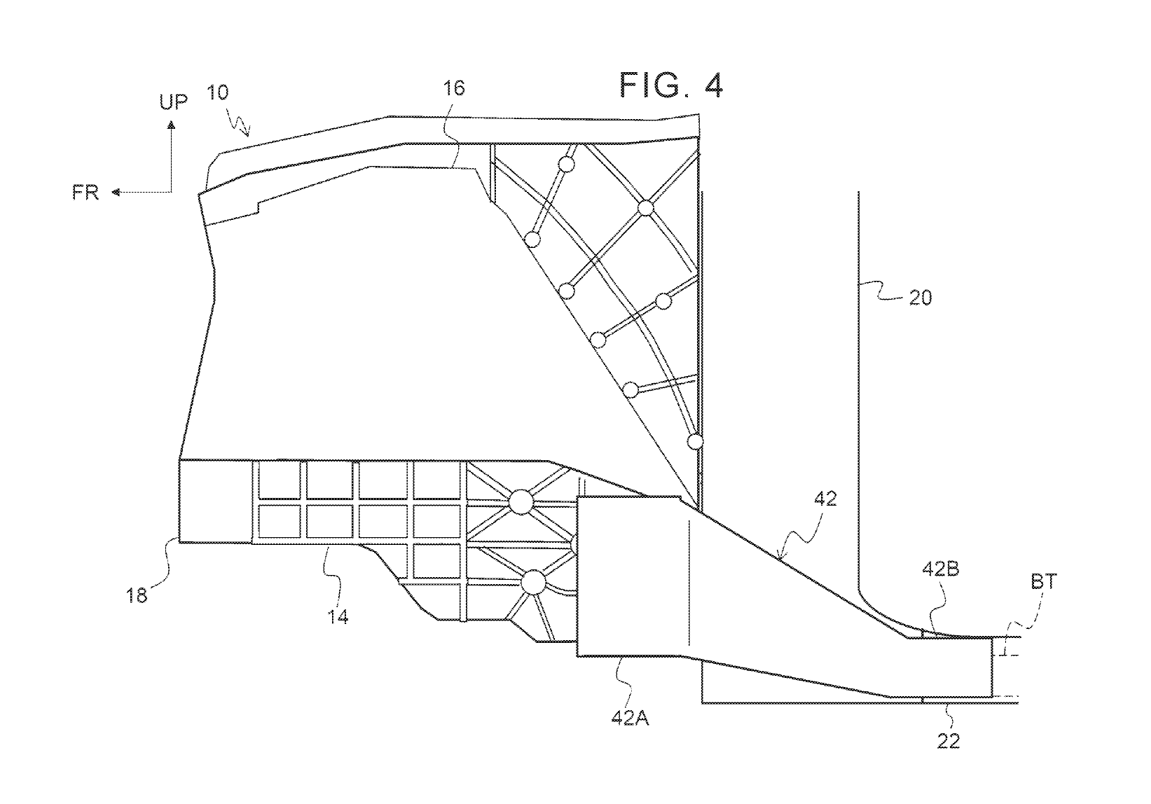

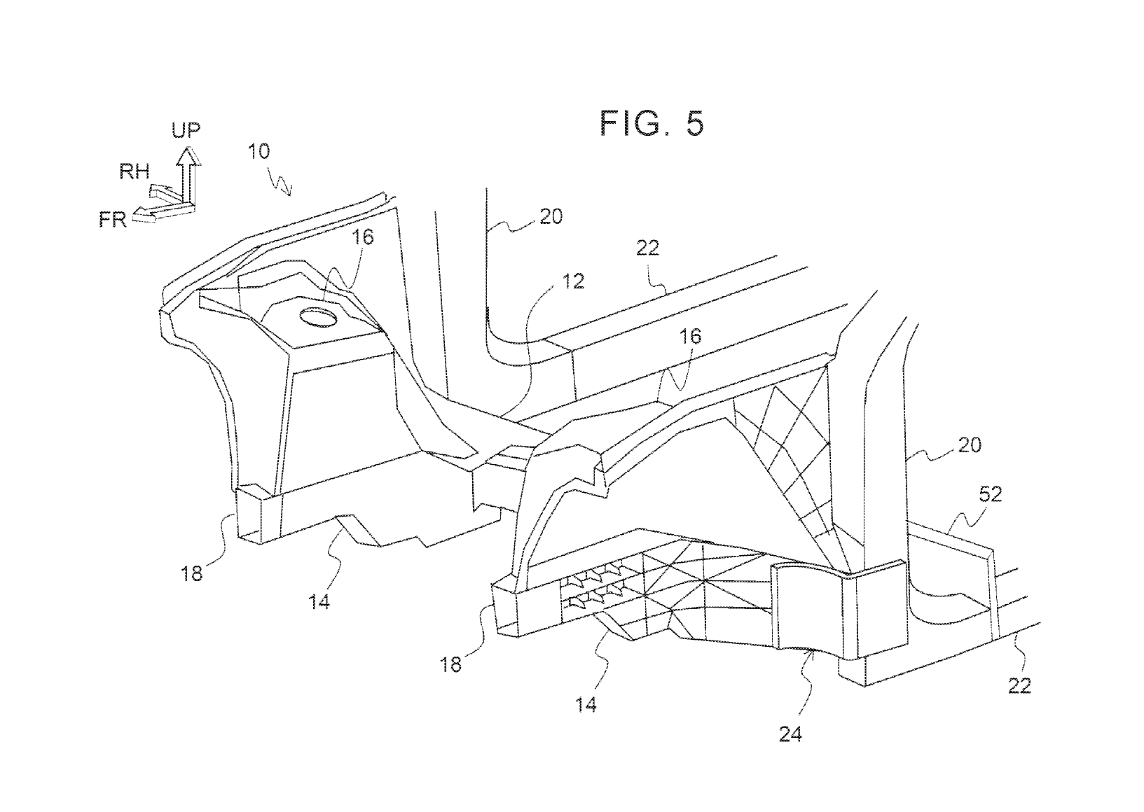

In the present embodiment, the coupling member 24 extends from the front side member portion 14 to the front pillar 20, but the present disclosure is not limited thereto. For example, the structure of the first modification shown in FIG. 4 may be adopted. Further, in the present embodiment, the front end of the rocker 22 is directly connected to the lower end of the front pillar 20, but the present disclosure is not limited thereto. For example, the structure of the second modification shown in FIG. 5 may be employed.

### First modification

FIG. 4 is a side view illustrating a main part of a vehicle skeleton structure according to a first modification. As shown in FIG. 4, the present modification has the same configuration as the embodiment except for the coupling member 42.

The coupling member 42 in the present modification example is disposed on the vehicle width direction outer side of the front skeleton body 10, and is formed by a substantially plate-shaped member.

The coupling member 42 mainly includes a front curved portion 42A attached to the front side member portion 14, a rear flat plate portion 42B attached to the rocker 22, and a connecting portion 42C connecting the front curved portion 42A and the rear flat plate portion 42B.

The front curved portion 42A is curved along the shape of the rear portion of the front side member portion 14. That is, the front curved portion 42A is curved so as to bulge inward in the vehicle-width direction, and is fastened to the rear end portion of the front side member portion 14 by a fastener (not shown). Therefore, a part of the opening of the rear portion of the front side member portion 14 is covered from the vehicle-width-direction outer side by the front curved portion 42A.

Further, the rear flat plate portion 42B is disposed on the vehicle lower side relative to the front curved portion 42A, and is fastened by a fastener (not shown) while being superposed on the vehicle width-direction outer surface of the rocker 22.

The connecting portion 42C is located between the front curved portion 42A and the rear flat plate portion 42B, and is formed in a substantially trapezoidal shape such that the vehicle rear side is shorter in length in the up-down direction than the vehicle front side when viewed from the vehicle width direction. The front end of the connecting portion 42C is connected to the front curved portion 42A, and the rear end of the connecting portion 42C is connected to the rear flat plate portion 42B.

As described above, in the present modification, the coupling member 42 extends to the rocker 22, and the front skeleton body 10, the front pillar 20, and the rocker 22 are connected by the coupling member 42. As a result, the effect of suppressing detachment of the front pillar 20 can be improved as compared with a structure in which the coupling member does not extend to the rocker.

### Second modification

FIG. 5 is a perspective view illustrating a main part of a vehicle skeleton structure according to a second modification. As shown in FIG. 5, in the present modification, the front skeleton body 10 includes an extension portion 52 extending downward from the dash portion 12.

The extension portion 52 extends in the vehicle width direction and extends from the rocker 22 on one side to the rocker 22 on the other side. Further, the extension portion 52 is connected to a front end portion of the rocker 22.

Here, the extension portion 52 also serves as a cross member of the front end portion of the battery case (not shown). Therefore, in the present modification example, the number of components of the battery case can be reduced. The extension portion 52 may be formed integrally with the dash portion 12 by casting, or may be formed of a separate body having a closed cross-sectional structure by a steel plate or the like.

Although the vehicle skeleton structure according to the present disclosure has been described above, it is needless to say that the present disclosure can be implemented in various forms without departing from the gist of the present disclosure. In the present embodiment, as shown in FIGS. 1 and 2, the coupling member 24 is attached to the rear portion of the front side member portion 14, but the present disclosure is not limited thereto. For example, the coupling member may be extended to the vehicle front side, and the entire curved region of the front side member portion 14 may be covered with the coupling member. In this case, since the rear portion of the front side member portion 14 is covered with the coupling member and has a closed cross-sectional structure, the proof stress is improved.

In the present embodiment, the connection portion 18 having a substantially rectangular cylindrical shape is provided at the front end of the front side member portion 14, but the present disclosure is not limited thereto. For example, it may be integrally formed by casting up to the region of the connection portion 18. In this case, a portion corresponding to the connecting portion has an open cross-sectional shape similarly to the front side member portion 14.

What is claimed is:

1. A vehicle skeleton structure comprising:
a front skeleton body integrally constituted by casting and including a dash portion disposed in a vehicle front portion and extending in a vehicle width direction, and a front side member portion extending from the dash portion toward a vehicle front side;
a front pillar constituted separately from the front skeleton body, attached to a rear end portion of the front skeleton body, and extending in a vehicle up-down direction; and
a coupling member disposed on a vehicle width direction outer side of the front skeleton body and coupling the front skeleton body and the front pillar.

2. The vehicle skeleton structure according to claim 1, wherein:
the front pillar is configured to include a pillar inner panel located on a vehicle width direction inner side, and a pillar outer panel located on the vehicle width direction outer side; and
the coupling member extends to a surface of the pillar outer panel on the vehicle width direction outer side.

3. The vehicle skeleton structure according to claim 1, wherein:
a front end of a rocker that extends in a vehicle front-rear direction is connected to a lower end portion of the front pillar;
the rocker is disposed on a vehicle lower side with respect to the front skeleton body; and
a battery is provided on a vehicle width direction inner side with respect to the rocker.

4. The vehicle skeleton structure according to claim 3, wherein the coupling member extends to the rocker.

5. The vehicle skeleton structure according to claim 3, wherein:
the front skeleton body includes an extension portion that extends downward from the dash portion; and
the extension portion extends in the vehicle width direction and is connected to a front end portion of the rocker.
